(19) United States
(12) Patent Application Publication
(10) Pub. No.: US 2004/0205044 A1
(43) Pub. Date: Oct. 14, 2004

(54) Method for storing inverted index, method for on-line updating the same and inverted index mechanism

(75) Inventors: Zhong Su, Beijing (CN); Yue Pan, Beijing (CN); Li Ping Yang, Beijing (CN)

Correspondence Address: RICHARD M. GOLDMAN, 371 ELAN VILLAGE LANE, SUITE 208, CA, 95134, US

(73) Assignee: International Business Machines Corporation

(21) Appl. No.: 10/818,833

(22) Filed: Apr. 6, 2004

(30) Foreign Application Priority Data
Apr. 11, 2003 (CN) 03-01-09847.9

(51) Int. Cl. G06F 17/30

(52) U.S. Cl. 707/2

(57) ABSTRACT

The invention provides a method for storing inverted index based on an inverted file, the method comprising: creating an inverted file in a storage medium for storing the inverted index, the inverted file including a plurality of fixed-size index blocks, each of them including a plurality of fixed-size index units, wherein each index unit is used to store one piece of index information; and sequentially storing the index information related to each index item into the created inverted file, wherein the index information related to the same index item is stored in continuous blocks and the index units in each index block are only for storing index information related to the same index item. Since each index block is used only for storing index information related to the same index item, when performing operations on the index information in an index block, other index items are not affected, therefore, it is possible to on-line update index information in any index block.

### BACKGROUND OF THE INVENTION

1. Technical Field

The present invention relates generally to information retrieval techniques, and specifically, to a method for storing an inverted index used for fill-text retrieval, a method for on-line updating the same and an inverted index mechanism.

2. Technical Background

According to the statistics, there are billions of web pages on the Internet, many of which have abundant information and being in a state of continuous change. The Internet provides a big stage for information retrieval techniques, and various kinds of search engines have been described. There are two kinds of techniques usually used by the existing search engines. One of the techniques is to use web site classifying technique, that is, to classify the web sites as a tree structure. A registered web site belongs to at least one category, and each web site is given a brief description. Another technique is to use the full-text retrieval technique. Text is the processing object of the full-text retrieval technique, which can create an inverted index, that is, the index from a word (term) to a document, for a large number of documents, such as a large number of web pages on the Internet. Based on the inverted index, when a user searches the documents (web pages) with keywords, the system will return to the user those documents (web pages) that contain the keywords. The advantage of creating an inverted index is that there is no need to search all the documents (web pages) for a user's query. In the search engines providing such full-text retrieval services there are usually two ways for using the inverted index. One way is to load the whole inverted index into the memory. Obviously, in this way the user's search request can be processed quickly. However, the search engines for searching the entire inverted index would need powerful hardware and complicated parallel-processing software. Therefore, most search engines choose to use a second way, that is, doing search directly on an inverted file which is used for storing inverted index and saved on an external storage device, such as a hard disk, and is accessed via read/write operation to obtain inverted index information, whereby the cost of the search engine in hardware and software will be reduced.

FIG. 1 shows the conventional method for storing an inverted index based on an inverted file.

Specifically, all documents are analyzed first to extract words (terms) that may become the objects of users' queries, and the extracted words (terms) are stored in a file together with the IDs of the corresponding documents, as shown in FIG. 1A.

After all the documents have been analyzed, the created file is ranked and merged according to the order of the extracted words (terms), and the occurrence frequencies of each word (term) in each document are calculated, as shown in FIG. 1B.

Finally, the above file is divided into two portions; one is called as a map file and the other as an inverted file. In the map file are stored the ranked words (terms) each of which has a pointer pointing to a record in the inverted file. On the other hand, the index information of each word (term), that is, the IDs of the documents containing the word (term), is stored in the inverted file. Other information may be included in these two files. As shown in FIG. 1C, the following fields are also included in the map file: the number of documents for indicating in how many documents a word (term) appears, and the total frequency for indicating the number of appearances of a word (term) in all documents. The inverted file also includes a field, frequency, for indicating the number of appearances of a word (term) in a document.

The appearance frequency of each word (term) in each document is generally quite different from each other. For example, some seldom-used words (terms) may appear in some documents only several times, and some popular or frequently used words (terms) may appear in many documents for hundreds or thousands times and even more. Thus, in the inverted file, the index information of some words (terms) only occupies a very small storage space, but the index information of some other words (terms) may occupy a large storage space. Therefore, in an inverted file, a variable length record is usually used to store the index information of each word (term). A disadvantage of this approach is that it is impossible to perform on-line updating operations (inserting/deleting). For example, a newly inserted piece of index information would cause all the pieces of index information following it to move backward. Not only would this increase the cost of disk I/O operation, but also this would make it impossible to on-line update the index information due to the time limitation. In the prior art, in order to update the index information, a general approach is to use two inverted files; one is a stable file, which is very large, including historical index information, and the other is a working file, which is relatively small, including only the recently updated index information. For example, if a user wants to insert a piece of new index information into the inverted file, only the working file is updated. Because this file is relatively small, the cost for updating operation would not too large. Accordingly, during a searching process, it is necessary to search these two files respectively and to provide the user with a combination of the searching results, whereas combining the records in the working file into the stable inverted file through off-line processing at nights or during non-interactive time period. The disadvantage of the above approach is that it is impossible to perform on-line updating for the inverted file.

### SUMMARY OF THE INVENTION

To solve this problem of making on-line updates of an inverted file, the present invention provides a new method for storing inverted index, a method for on-line updating the same and an inverted index mechanism supporting on-line updating.

According to an aspect of the invention, there is provided a method for storing inverted index based on an inverted file. The method comprises:

creating an inverted file in a storage medium for storing inverted index, where the inverted file includes a plurality of fixed-size index blocks, each of which index blocks includes a plurality of fixed-size index units, wherein each index unit is used to store one piece of index information; and

sequentially storing the index information related to each index item into the created inverted file, wherein the index information related to the same index item is stored in continuous index blocks, and the index units in each index block are only for storing the index information related to the same index item.

According to another aspect of the present invention, there is provided a method for on-line inserting a new piece of index information in the above created inverted file. The method comprises the steps of:

extracting a corresponding index item from the new piece of index information to be inserted, and copying all index blocks corresponding to the index item into the memory;

setting the on-line updating flag for the index item;

checking whether there is any empty index unit in the index blocks corresponding to the index item; if there is an empty index unit, writing the piece of index information into the found empty index unit, otherwise creating a new index block at the end of the inverted file, and writing the piece of index information into the newly created index block and updating the information in the block header of the present index block; and

resetting the on-line updating flag for the index item.

According to yet another aspect of the present invention, there is provided a method for on-line deleting a piece of index information from the above created inverted file. The method comprises the steps of:

extracting a corresponding index item from the piece of index information to be deleted, and copying all index blocks corresponding to the index item into the memory;

setting the on-line updating flag for the index item;

finding the index unit that stores the piece of index information from the index blocks corresponding to the index item, setting the flag bit of the index unit to indicate that the index unit is empty; and

resetting the on-line updating flag for the index item.

According to still another aspect of the present invention, there is provided a method for on-line defragmenting the above created inverted file, the method comprises the steps of:

creating a new inverted file in a storage medium, which has the same format as that of the old inverted file mentioned above;

sequentially processing each index item;

copying all index blocks related to the index item from the old inverted file to the memory;

setting the on-line defragment flag of the index item;

sequentially writing the index blocks related to the index item into the newly created inverted file;

resetting the on-line defragment flag; and

stopping the searching service on the old inverted file and beginning the searching service on the new inverted file.

According to still another aspect of the present invention, there is provided an inverted index mechanism supporting on-line updating, the inverted index mechanism comprises:

an inverted file, including: a plurality of fixed-size index blocks, where each block includes a plurality of fixed-size index units, each index unit is used for storing one piece of index information, wherein the index information related to the same index item is stored in continuous index blocks, and the index units in each index block are only used for storing index information related to the same index item;

a retrieval unit for retrieving documents, according to the keyword input by the user. This is done by means of the inverted file, evaluating the correlation degree between the documents and the query, ranking the results to be output, and returning the searching results to the user; and

an on-line updating unit for on-line inserting/deleting index information into/from the inverted file.

In the method for storing inverted index based on an inverted file according to the present invention, due to storing all the index information related to the same index item into continuous index blocks, when reading the index information on an arbitrarily chosen index item, there is no need to relocate the reading pointer to the file. Therefore, it is possible to reduce the time taken for the file reading operation. It should be noted that in the method for storing inverted index based on an inverted file according to the present invention, each index block is used only for storing the index information related to the same index item. Thus, when performing an operation on the index information in an index block, other index items are not affected, therefore, it is possible to on-line update the index information in any index block through a simple locking-unlocking method without having to stop searching service.

### DESCRIPTION OF THE DRAWINGS

These and other advantages, objectives and features of the present invention will become clearer through the description of preferred embodiments of the present invention with reference to the following drawings, in which:

FIG. 1 shows a prior art method for storing an inverted index based on an inverted file;

FIG. 2 shows the method for storing an inverted index based on an inverted file according to a preferred embodiment of the present invention;

FIG. 3 shows four map files related to the operations of accessing and updating the inverted file;

FIG. 4 is a flowchart illustrating the process of accessing the inverted file according to a preferred embodiment of the present invention;

FIG. 5 is a flowchart illustrating the process of on-line inserting index information into the inverted file according to a preferred embodiment of the present invention;

FIG. 6 is a flowchart illustrating the process of on-line deleting index information from the inverted file according to a preferred embodiment of the present invention;

FIG. 7 is a flowchart illustrating the process of defragmenting the inverted file according to a preferred embodiment of the present invention; and

FIG. 8 shows the composition of the inverted index mechanism according to the present invention.

### DETAILED DESCRIPTION OF THE INVENTION

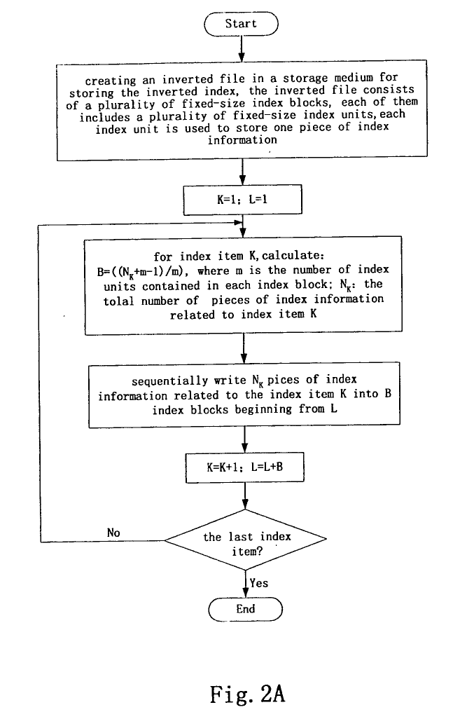

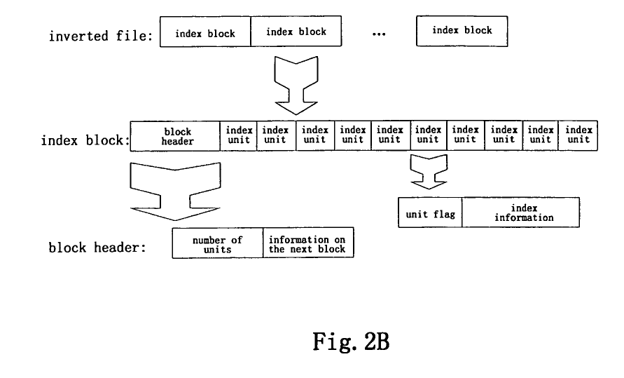

FIG. 2 shows the method for storing inverted index based on an inverted file according to a preferred embodiment of the present invention. As shown in FIG. 2A, in the method for storing inverted index based on an inverted file according to a preferred embodiment of the present invention, an inverted file is created first in a storage medium for storing inverted index. The format of the inverted file is shown in FIG. 2B. The storage medium may be directly accessible non-volatile storage medium, such as hard disk, CD-ROM and the like. The inverted file consists of a plurality of fixed-size index blocks, and each of them includes the same number of fixed-size index units. Each index unit is used to store one piece of index information. After the inverted file, as shown in FIG. 2B, has been created, for any index item K the number of index blocks required by the index item is calculated as B=int((Nk+m−1)/m). Then, the index information related to the index item is sequentially stored into the B index blocks from L, where m is the number of index units contained in each index block; Nk is the number of pieces of index information related to the index item K; L is a pointer pointing to an index block in the inverted file, from the index block L, B continuous index blocks will be used to store the index information related to the index item K, the initial value of L is 1. It can be seen that in the method for storing inverted index based on an inverted file according to the present invention, the index information related to the same index item is stored in continuous blocks, and the index units in each index block are only for storing the index information related to the same index item.

As discussed above, in text-based searching, the popularity and the frequency of use of a word (term) (or index item) make the frequencies of appearances of the word in the documents great different from that of the others. A seldom-used word (term) may appear in some documents only several times, and a popular common-used word (term) may appear in many documents for hundreds or thousands times (or even more). Thus, the numbers of index blocks required by different index items are different. As described above, for any index item K, if it appears in individual documents for Nk times, then int((Nk+m−1)/m) index blocks are required for storing the index information related to the index item. In the method for storing inverted index based on an inverted file, the index information related to the same index item is stored in continuous index blocks of the inverted file, thus, when reading index information related to an arbitrarily chosen index item, there is no need to relocate the reading pointer to the file, therefore, it is possible to reduce the time taken for the file reading operation. Besides, in the method for storing inverted index based on an inverted file according to the present invention, each index block in the inverted file is used only for storing the index information related to the same index item. Thus, when performing an operation on the index information in an index block, other index items are not affected; therefore, it is possible to on-line update index information in any index block by a simple locking-unlocking method without having to stop searching service.

When determining the number of index units contained in an index block, the major concern is the consumption of disk storage.

If the number of units contained in an index block is too small, the number of index blocks corresponding to each index item would be increased, and because there is a fixed-size block header for each index block. Therefore, a lot of storage space would be wasted at the block headers, but, because the size of an index block is too small, the probability of generating fragments in the inverted file would be increased during the process of on-line updating described later. Therefore, the searching efficiency will be affected in the practical applications.

If the number of index units contained in an index block is too large, there is also a problem. Most index items usually appear in documents for a small number of times, for example, according to the statistics with 2550 randomly chosen web pages on the Sina newsnet, 30444 different index items are found in total. But, among them 20657 words appear 5 or fewer times. Therefore, if the number of index units contained in an index block is too large, a lot of low frequency words would cause large amount of storage space to be wasted, also affecting the searching efficiency of the system.

Therefore, a tradeoff is required between these two situations. According to the specific user's corpus, the number of index units in each index block may be determined based on the percentage of idle storage space.

In addition, it may be considered to optimize the number of index units in an index block based on the configuration of the file system. The more index units an index block contains, the larger the size s will become. Considering the size M of a file block in the disk, if s divides M or M divides s, the file blocks and the index blocks may be aligned when creating an inverted file, therefore, the number of file blocks read during reading index blocks would be reduced, achieving the objective of optimization.

In the inverted file as shown in FIG. 2B, each index block contains a block header and 10 index units. For those skilled in the art, it is obvious that the preferred embodiment is only for the purpose of illustration and should not be considered to be a limitation to the present invention. In various embodiments, the number of index units contained in an index block may be determined according to the user's corpus.

In the inverted file as shown in FIG. 2B, the following fields are included in the block header: a number of units, for indicating the number of non-empty index units in the index block; information on the next block, wherein “0” indicating the index block is the last index block for storing index information of the index item; “1” indicating that the next index block closely subsequent to the index block is still for storing the index information of the index item; and the other value that is an offset address, for example the number of blocks offset from the beginning of the file, indicating that another index block that is not closely subsequent to the index block is also for storing the index information of the index item, the address of the other index block that is not closely subsequent to the index block can be obtained from the offset address. It will be discussed later that due to the operation of on-line updating, some index information will be stored in discontinuous index blocks, that is, producing fragments. However, these fragments can be eliminated by a defragment operation.

Besides, in the inverted file as shown in FIG. 2B, each index unit contains the following fields: a unit flag, “1” indicating that in the unit the index information is stored and “0” indicating that the unit is an empty unit; and the index information for storing the IDs of the documents, the appearance frequency of the index item (word, term) in the document, and so on.

From the above it can be seen that in the method for storing inverted index based on an inverted file according to the present invention, since all index information related to the same index item is stored in the continuous index blocks of the inverted file, the access speed may be improved during the searching process. In addition, since each index block in the inverted file stores only the index information related to the same index item, the operation of updating for any index block will not affect other index items, thus, the inverted file may be updated without stopping searching service, as a result, the method for storing inverted index based on an inverted file according to the present invention supports the operation of on-line updating.

Next, a detail description will be given to the operations of accessing and on-line updating the above created inverted file.

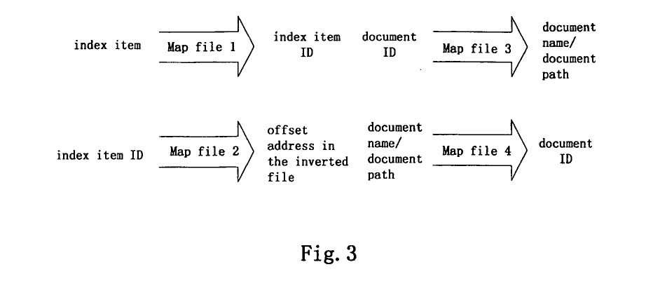

FIG. 3 shows four map files related to the operations of accessing and updating the inverted file, wherein

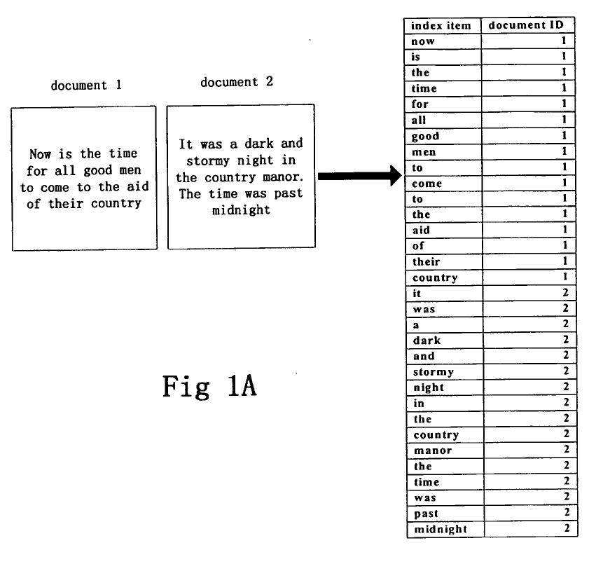

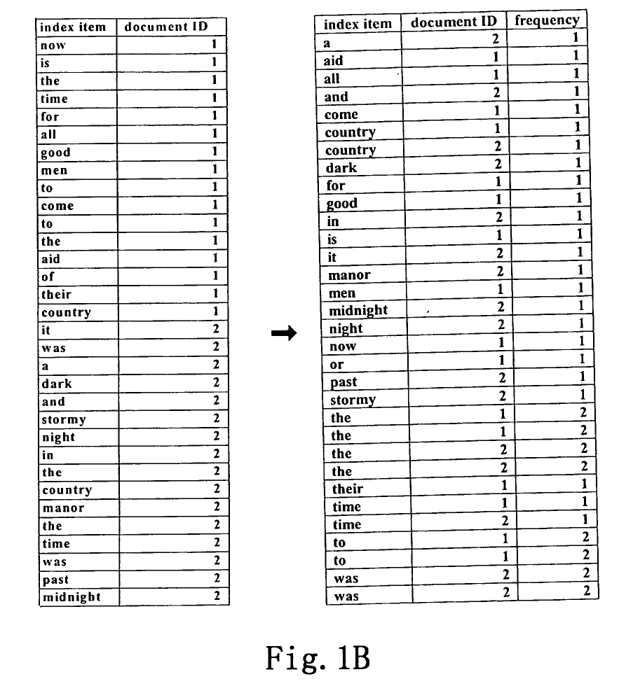

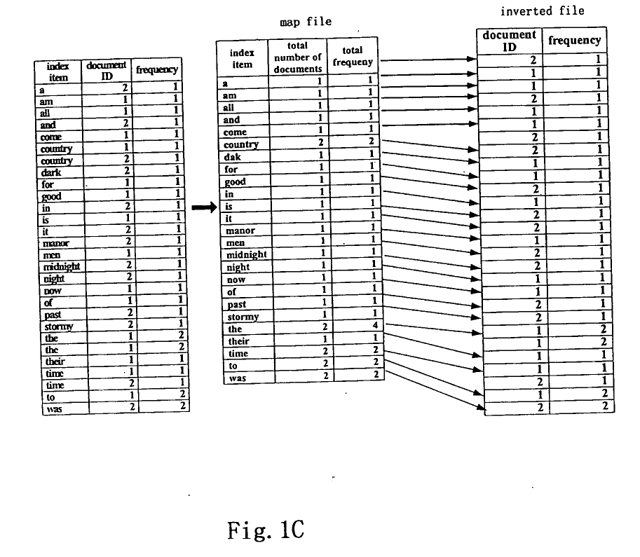

Map file 1 provides the mapping from an index item (word, term) to an index item's ID. Each index item, that is, keyword (term) as usually referred to, has a unique number, that is, the index item's ID corresponding to it one by one. In this way, during the processes for storing and searching, a number may be used to represent the keyword (term), with reducing storage space and improving the search speed. For example, by using the index items' IDs, the index items stored in the map file shown in FIG. 1C may be substituted with their IDs.

Map file 2 provides the mapping from an index item's ID to an offset address in the inverted file. The mapping table from each index item's ID to its offset address in the inverted file gives, for each index item, the offset address of the first index block containing the index item in the inverted file. Thus, a corresponding relation between the index items and their corresponding index blocks in the inverted file are established. If the offset address N>=0, it indicates that the index information of the index item is located at N*(size of an index block), from the beginning of the inverted file; if the offset address N<0, it indicates that the index information of the index item is being updated and the original index information has been copied into the memory.

Map files 3 and 4 provide the mapping between the documents' IDs and the paths of these documents. Thus, in the index, documents' IDs may be used to represent the address of the document that is stored at a specific location; and if the document's ID is known, the content of the document will be found through the mapped document path. With map files 3 and 4, the mapping from the document IDs to the document names/document paths is realized.

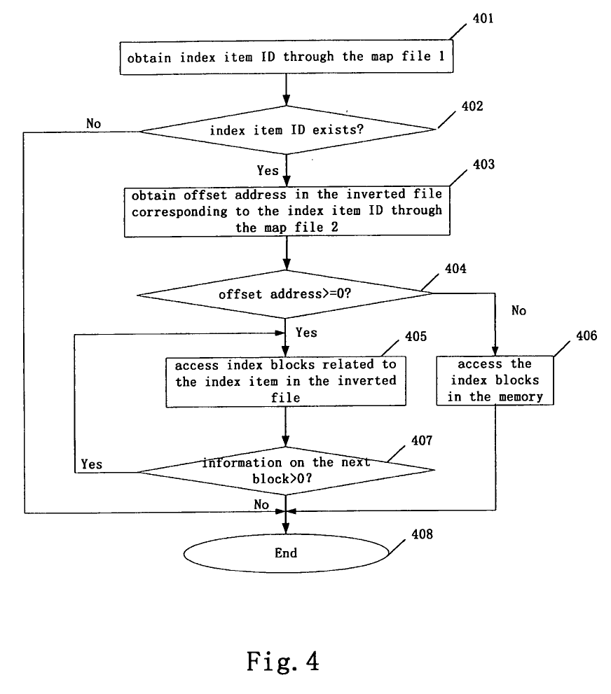

The process of accessing the inverted file is described with reference to FIG. 4. As shown in FIG. 4, the index item's ID is first obtained through the map file 1 (Step 401). Then, for the index item's ID, the corresponding offset address in the inverted file is obtained by using the map file 2 (Step 403). If the offset address is smaller than zero, it indicates that the index information of the index item is being updated, since in this case all index blocks related to the index item have been copied into the memory, it is possible to access directly these index blocks in the memory (Steps 404 and 406). If the offset address is greater than or equal to zero, then the index block related to the index item will be accessed according to the offset address (Step 404 and 405). After that, it is checked whether the information on the next block in the block header of the present index block is greater than zero or not (Step 407). If it is, this indicates that there exists other index information related to the index item, access to the inverted file continues according to the information on the next block (return to Step 402). If the information on the next block is not greater than zero, this indicates that the present index block is the last index block related to the index item and the accessing operation is ended (Step 408).

From the above it can be seen that, if all index information related to an index item is stored in continuous index blocks (no fragments), the operation of accessing the index information of an index item is to access continuous index blocks in the inverted file without having to move the file read pointer, as a result, the access speed is very high.

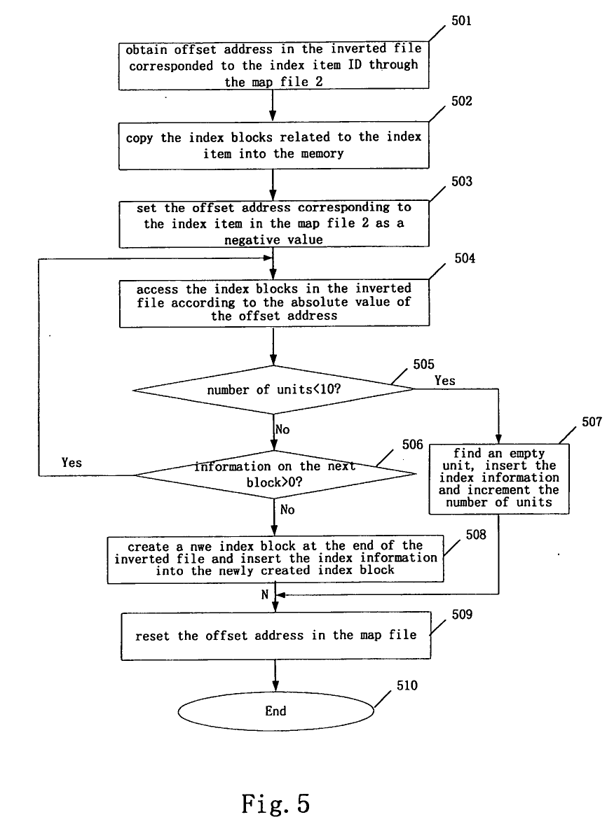

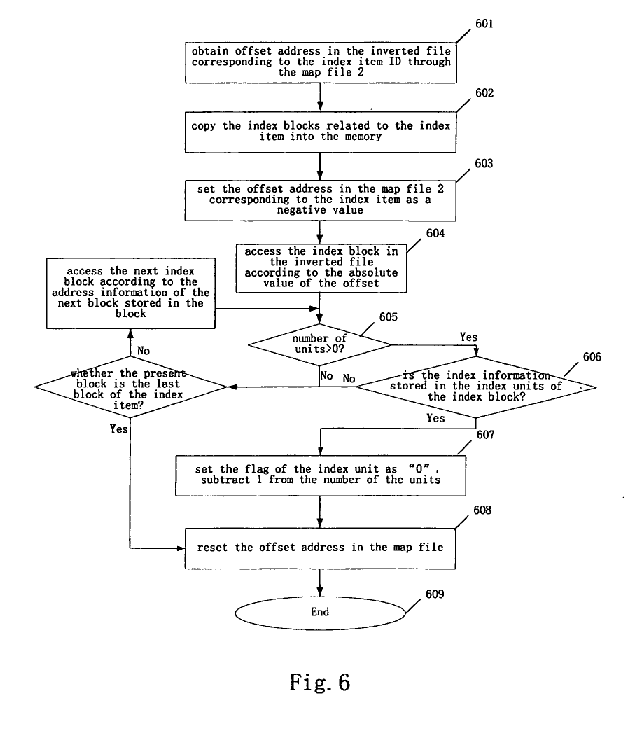

The operation of on-line updating the above-mentioned inverted file will be described in detail with reference to FIGS. 5 and 6, wherein FIG. 5 shows the operation of on-line inserting and FIG. 6 shows the operation of on-line deleting.

As shown in FIG. 5, in order to insert a new piece of index information into the inverted file, the address of the first index block where the index information of the index item is stored, that is, the offset address relative to the beginning of the inverted file, is obtained first through the map file 2 (Step 501). Then, the first index block used to store the index information of the index item is found according to the offset address, and all other index blocks used to store the index information of the index item are found according to the information on the next block in the block header of each index block, then all of the index blocks are copied into the memory (Step 502). Further, the offset address of the index item is set to a negative value, indicating that operation of on-line updating the index item is being performed (Step 503). Thereafter, the inverted file is accessed according to the offset address and the information on the next block in the block header, in order to find an empty unit, and the index information is written to the found empty unit, then the unit number in the block header of the present index block is incremented (Steps 505, 506 and 507). If any empty unit is not found in the index blocks related to the index item, a new index block is created at the end of the inverted file and the index information is written into the first index unit of the newly created index block, and the information on the next block in the block header of the present index block is updated (Step 508). Finally, the offset address is reset (Step 509) and the operation of on-line inserting is ended (Step 510). From the above it can be seen that, if no empty index unit is found in the index blocks related to the index item during the process of on-line inserting, the index information to be inserted will be written into the newly created index block at the end of the inverted file, this will result in the index blocks related to the same index item are not continuous, that is, fragments are generated. These fragments, however, may be eliminated through the defragment operation that will be described later.

FIG. 6 shows the operation of on-line deleting. As shown in FIG. 6, the address of the first index block where the index information of the index item is stored, that is, the offset address relative to the beginning of the inverted file, is obtained first through the map file 2 (Step 601). Then, the first index block used to store the index information of the index item is found according to the offset address, and all other index blocks used to store the index information of the index item are found according to the information on the next block in the block header of each index block, then all of the index blocks are copied into the memory (Step 602). Thereafter, the offset address of the index item is set to a negative value, indicating that operation of on-line updating the index item is being performed (Step 603). After that, the index blocks in the inverted file are searched one by one, according to the offset address and the information on the next block in the block header of each index block, in order to find the index unit which is used to store the index information, and the flag of the index unit is set to zero, indicating that the index unit is empty, then the unit number in the block header of the present index block is subtracted by 1 (Steps 604, 605, 606 and 607). Finally, the offset address is reset (Step 608) and the operation of on-line deleting is ended (609).

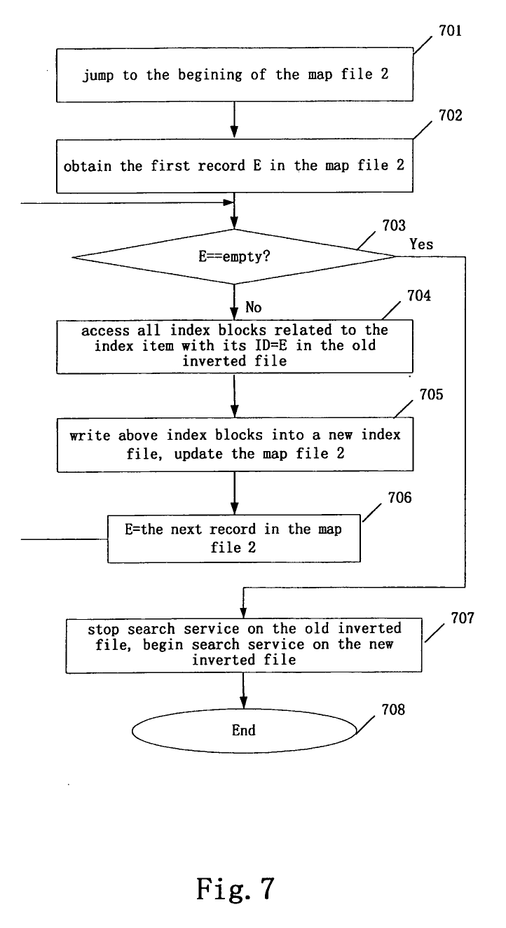

From the above it can be seen that, either the operation of on-line inserting or the operation of on-line deleting may cause the index information related to the same index item no longer to be stored in continuous index blocks, this would reduce the speed of accessing the inverted file, so it is required to perform defragment regularly. FIG. 7 shows this defragment operation. This defragment operation may also be an on-line operation without stopping search service.

As shown in FIG. 7, the basic working procedure is to process all index items and their corresponding index blocks in the inverted file by traversing the map file 2, ensuring that all the index blocks corresponding to each index item are continuously distributed in the new inverted file physically, therefore, the “fragments” can be eliminated.

Steps 701, 702, 703 and 706 are the processes of traversing the map file 2, in this case, all index items are traversed one by one. For each index item, via the offset address corresponding to the index item's ID in the map file 2 and the information on the next block in the index block, all index blocks corresponding to the index item's ID in the old inverted file can be accessed (704). Then, for all index blocks except the last one, the information on the next block is changed to “1”, and the new index blocks are sequentially written into the new inverted file (705). When all the processes have completed, the search service on the old inverted file may be stopped and the service will begin with the new file (707).

In the method for storing inverted index based on an inverted file according to the present invention, each index block in the inverted file is only correlated with one index item, that is, it is used for storing index information of the same index item. Therefore, the operation on any index block in the inverted file will not affect the other index items, so it is not necessary to stop search service. Thus, the defragment operation may be an on-line operation. If the defragment operation is performed on-line, it is necessary to set or reset the flag of on-line defragment before or after processing each index item.

The method for storing inverted index based on an inverted file and the methods for on-line updating or defragmenting the inverted file according to preferred embodiments of the present invention have been described in detail. For those skilled in the art, it is obvious that an inverted index mechanism supporting on-line updating is easily obtained on the basis of above-mentioned content.

So called the index mechanism is a computer system that can create index for information resources and provides search service to the user's query. Accordingly, an inverted index mechanism is meant as a computer system that can create inverted index for text information and provide full-text search service to the user's query. Typically, the work of an inverted index mechanism comprises the following three processes: 1. searching text information; 2. extracting text information and creating an inverted file; and 3. searching out documents based on the keyword input by the user, by means of the inverted file, evaluating the correlation degree between these documents and the query, ranking the results to be output, and returning the search results to the user. In addition, the work of the index mechanism usually further comprises a process for updating (inserting/deleting) index information in the inverted file. However, as mentioned above, due to the limitation of the structure of existing inverted files, this kind of operations for maintenance can only be performed off-line. For this reason, according to another aspect of the present invention, there is provided an inverted index mechanism supporting on-line updating.

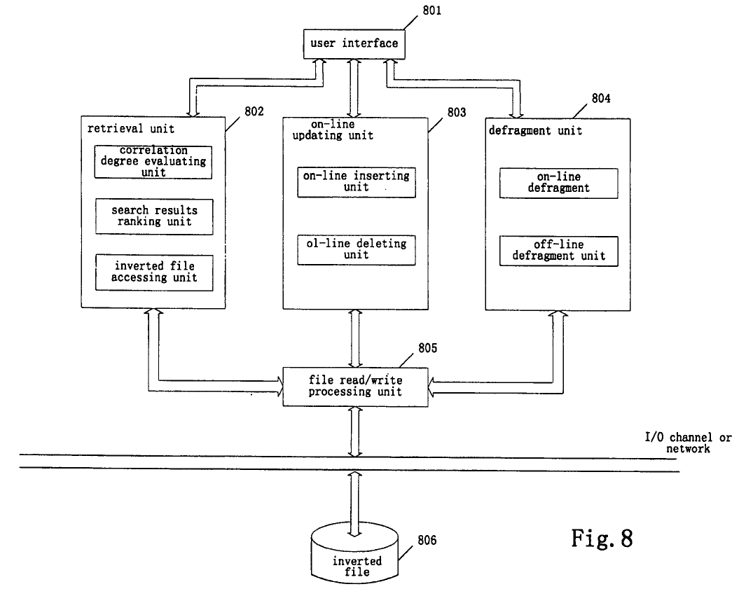

As shown in FIG. 8, the inverted index mechanism according to a preferred embodiment of the present invention comprises: a user interface 801, a retrieval unit 802, an on-line updating unit 803, defragment unit 804, a file read/write processing unit 805 and an inverted file 806. Among them, the user interface 801 is used to receive various user inputs or output various search results. The retrieval unit 802, including an inverted file access unit, a correlation degree evaluation unit and a search results ranking unit, is used for searching out documents based on the keyword input by the user, by means of the inverted file, evaluating the correlation degree between these documents and the query, ranking the results to be output, and returning the search results to the user. The on-line updating unit 803, including an on-line inserting unit and an on-line deleting unit, is used to on-line inserting/deleting index information in the inverted file, the operation processes are as shown in FIGS. 5 and 6. The defragment unit 804, including an on-line defragment unit and an off-line defragment unit, is used to on-line or off-line eliminate fragments (discontinuous index blocks) in the inverted file, the operation process is as shown in FIG. 7. The file read/write processing unit 805 is used to read or modify the inverted file mentioned above via an I/O channel or network, wherein the file read/write processing unit may read a plurality of continuous index blocks related to one index item by one file read operation. The inverted index file 806 is created by the method for storing inverted index based on an inverted file according to the preferred embodiment of the invention as shown in FIG. 2. This inverted file may be stored on various storage media, for example, the directly accessible non-volatile storage media, such as magnetic disk and optical disk.

For those skilled in the art, it is obvious that the inverted index mechanism supporting on-line updating according to the preferred embodiment of the present invention may be implemented as either a computer system or a program recorded on any computer-readable storage medium. In addition, the inverted file and the processing units may reside on the same computer or be distributed over different computers connected together via a network.

Program Product

The invention may be implemented, for example, by having the inverted index solution execute a sequence of machine-readable instructions, which can also be referred to as code. These instructions may reside in various types of signal-bearing media. In this respect, one aspect of the present invention concerns a program product, comprising a signal-bearing medium or signal-bearing media tangibly embodying a program of machine-readable instructions executable by a digital processing apparatus to perform a method for inverted indexing.

This signal-bearing medium may comprise, for example, memory in server. The memory in the server may be non-volatile storage, a data disc, or even memory on a vendor server for downloading to a processor. Alternatively, the instructions may be embodied in a signal-bearing medium such as the optical data storage disc. Alternatively, the instructions may be stored on any of a variety of machine-readable data storage mediums or media, which may include, for example, a “hard drive”, a RAID array, a RAMAC, a magnetic data storage diskette (such as a floppy disk), magnetic tape, digital optical tape, RAM, ROM, EPROM, EEPROM, flash memory, magneto-optical storage, paper punch cards, or any other suitable signal-bearing media including transmission media such as digital and/or analog communications links, which may be electrical, optical, and/or wireless. As an example, the machine-readable instructions may comprise software object code, compiled from a language such as “C++”.

Additionally, the program code may, for example, be compressed, encrypted, or both, and may include executable files, script files and wizards for installation, as in Zip files and cab files. As used herein the term machine-readable instructions or code residing in or on signal-bearing media include all of the above means of delivery.

Other Embodiments

While the foregoing disclosure shows a number of illustrative embodiments of the invention, it will be apparent to those skilled in the art that various changes and modifications can be made herein without departing from the scope of the invention as defined by the appended claims. Furthermore, although elements of the invention may be described or claimed in the singular, the plural is contemplated unless limitation to the singular is explicitly stated.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A method for storing an inverted index based on an inverted file, the method comprising:
creating an inverted file in a storage medium for storing the inverted index, the inverted file includes a plurality of fixed-size index blocks, at least one of which includes a plurality of fixed-size index units, wherein each index unit is used to store one piece of index information; and
sequentially storing the index information related to each index item into the created inverted file, wherein the index information related to the same index item is stored in continuous blocks, and the index units in each index block are only used for storing the index information related to the same index item.

2. The method for storing inverted index based on an inverted file according to claim 1, wherein each index block further includes a block header, the block header including fields for: a number of units for indicating the number of non-empty index units in the index blocks; and information on the next block indicating the location of the next index block related to the present index item.

3. A method for on-line inserting a new piece of index information in an inverted file, wherein said inverted file includes: a plurality of fixed-size index blocks, each of which includes a plurality of fixed-size index units, each index unit being used to store one piece of index information, wherein the index information related to the same index item is stored in continuous index blocks and the index units in each index block are used only for storing the index information related to the same index item, the method comprising the steps of:
extracting a corresponding index item from a new piece of index information to be inserted, and copying index blocks corresponding to the index item into the memory;
setting the on-line updating flag for the index item;
checking whether there is any empty index unit in the index block corresponding to the index item;
if there is, writing the piece of index information into the found empty index unit, otherwise creating a new index block at the end of the inverted file, and writing the piece of index information into the newly created index block and updating information in the block header of the present index block; and
resetting the on-line updating flag for the index item.

4. A method for on-line deleting a piece of index information in an inverted file, wherein said inverted file includes: a plurality of fixed-size index blocks, each of said blocks includes a plurality of fixed-size index units, each index unit is used to store one piece of index information, wherein the index information related to the same index item is stored in continuous index blocks and the index units in each index block are used only for storing the index information related to the same index item, the method comprising the steps of:
extracting a corresponding index item from the piece of index information to be deleted, and copying all index blocks corresponding to the index item into the memory;
setting the on-line updating flag for the index item;
finding the index unit that stores the piece of index information from the index blocks corresponding to the index item, setting the flag bit of the index unit to indicate that the index unit is empty; and
resetting the on-line updating flag for the index item.

5. A method for on-line defragmenting an inverted file, wherein said inverted file includes: a plurality of fixed-size index blocks, at least one said blocks including a plurality of fixed-size index units, each index unit storing one piece of index information, wherein the index information related to the same index item is stored in continuous index blocks and the index units in each index block are used only for storing the index information related to the same index item, the method comprising the steps of:
creating a new inverted file in a storage medium, which has the same format as that of the old inverted file mentioned above;
sequentially processing each index item:
copying all index blocks related to the index item from the old inverted file to the memory;
setting the on-line defragment flag of the index item;
sequentially writing the index blocks related to the index item into the newly created inverted file; and
resetting the on-line defragment flag of the index item; and
stopping the searching service on the old inverted file and beginning the searching service on the new inverted file.

6. An inverted index mechanism adapted for on-line updating, the inverted index mechanism comprising:
an inverted file, including: a plurality of fixed-size index blocks, each block including a plurality of fixed-size index units, each index unit being used for storing one piece of index information, wherein, index information related to the same index item is stored in continuous index blocks, and the index units in each index block are only used for storing index information related to the same index item;
a retrieval unit for retrieving documents, based on the keyword input, by means of the inverted file, evaluating the correlation degree between the documents and the query, ranking the results to be output, and returning the searching results to the user; and
an on-line updating unit for on-line inserting/deleting index information into/from the inverted file.

7. The inverted index mechanism supporting on-line updating according to claim 6, further comprising a defragment unit for on-line or off-line eliminating fragments in the inverted file.

8. A program product comprising a signal-bearing media tangibly embodying a program of machine-readable instructions executable by a digital processing apparatus to perform a method for storing an inverted index based on an inverted file, the method comprising:
creating an inverted file in a storage medium for storing the inverted index, the inverted file includes a plurality of fixed-size index blocks, at least one of which includes a plurality of fixed-size index units, wherein each index unit is used to store one piece of index information; and
sequentially storing the index information related to each index item into the created inverted file, wherein the index information related to the same index item is stored in continuous blocks, and the index units in each index block are only used for storing the index information related to the same index item.

9. The program product for storing inverted index based on an inverted file according to claim 8, wherein each index block further includes a block header, the block header including fields for: a number of units for indicating the number of non-empty index units in the index blocks; and information on the next block indicating the location of the next index block related to the present index item.
